(19) United States
(12) Patent Application Publication
(10) Pub. No.: US 2005/0197226 A1
(43) Pub. Date: Sep. 8, 2005

(54) Planetary gear set

(76) Inventors: Norihiro Yamamura, Nishikamo-gun (JP); Yuji Yasuda, Nishikamo-gun (JP); Naoki Kato, Aichi-gun (JP)

Correspondence Address: KENYON & KENYON, 1500 K STREET NW, SUITE 700, WASHINGTON, DC, 20005, US

(21) Appl. No.: 11/060,410

(22) Filed: Feb. 18, 2005

(30) Foreign Application Priority Data
Mar. 3, 2004 (JP) 2004-059354

(51) Int. Cl. F16H 57/04

(52) U.S. Cl. 475/159

(57) ABSTRACT

A planetary gear set including a sun gear; a carrier which rotatably supports multiple pinions meshed with the sun gear; and a ring gear in which internal teeth meshed with the pinions are formed in an inner peripheral surface and in which spline grooves are formed on an outer peripheral surface such that the ring gear serves as a hub of friction plates. A groove is formed along an entire circumference of part of the inner peripheral surface of the ring gear. Oil holes for introducing lubricating oil from the inner peripheral side to the outer peripheral side of the ring gear are formed such that one end of each of the oil holes opens at a bottom of the groove.

### INCORPORATION BY REFERENCE

The disclosure of Japanese Patent Application No. 2004-059354 filed on Mar. 3, 2004 including the specification, drawings and abstract is incorporated herein by reference in its entirety.

### BACKGROUND OF THE INVENTION

1. Field of the Invention

The invention relates to a planetary gear set. More particularly, the invention relates to a planetary gear set whose ring gear also serves as a hub of friction plates.

2. Description of the Related Art

Generally, an automatic transmission includes multiple planetary gear sets. A planetary gear set includes three rotational elements, that are, a sun gear, a ring gear, and a carrier which rotates coaxially with the sun gear and the ring gear, and pinions each of which is supported by the carrier so as to be rotatable on its axis and each of which is meshed with the sun gear and the ring gear. Also, the automatic transmission includes friction plates, namely, a clutch or a brake, which selectively couples or stops the three rotational elements of the planetary gear set.

In an automatic transmission having such a structure, a ring gear may also serve as a hub of friction plates, for example, as disclosed in Japanese Patent Application Publication No. JP-A-2003-97678. When the ring gear is also used as the hub of the friction plates, spline grooves, which are engaged with the friction plates, are formed in an outer peripheral surface of the ring gear. In addition, as disclosed in Japanese Patent Application Publication No. JP-A-2003-97678, oil holes, which introduce lubricating oil from an inner peripheral side to an outer peripheral side of the ring gear, are formed in the ring gear. These oil holes introduce the lubricating oil, which has reached an inner peripheral surface of the ring gear, to the outer peripheral side of the ring gear, and the friction plates are thus lubricated.

Each of the oil holes is formed so as to open at a root of internal teeth of the ring gear, at which the lubricating oil is accumulated relatively easily. However, there are cases where the lubricating oil is not accumulated sufficiently even at the root of the internal teeth, and therefore the amount of lubricating oil supplied to the friction plates, which are provided on the outer peripheral side of the ring gear, is not sufficient. Each of the oil holes is formed by piercing the ring gear from the outer peripheral side of the ring gear. When the oil holes are formed in a portion at which the internal teeth are formed, phases of both the spline grooves and the internal teeth need to be taken into consideration.

### SUMMARY OF THE INVENTION

The invention is made in light of the above-mentioned circumstances. It is therefore an object to provide a planetary gear set having good lubricity for friction plates, when a ring gear also serves as a hub of the friction plates.

According to an aspect of the invention, there is provided a planetary gear set including a sun gear; a carrier which rotatably supports multiple pinions meshed with the sun gear; and the ring gear in which internal teeth meshed with the pinions are formed in an inner peripheral surface and in which spline grooves are formed in an outer peripheral surface such that the ring gear serves as a hub of friction plates. A groove is formed along the entire circumference of part of the inner peripheral surface of the ring gear. Oil holes for introducing the lubricating oil from the inner peripheral side to the outer peripheral side of the ring gear are formed such that one end of each of the oil holes opens at a bottom of the groove.

With the planetary gear set having the above-mentioned structure, the groove is formed along the entire circumference of part of the inner peripheral surface of the ring gear. Therefore, the lubricating oil is easily accumulated in the groove. Also, the oil holes are open at the bottom of the groove. Accordingly, lubricity for the friction plates provided on the outer peripheral surface of the ring gear is increased. When the oil holes are formed in a portion at which the internal teeth are formed, it is not necessary to take the phase relationship between the spline grooves and the internal teeth of the ring gear into consideration.

### BRIEF DESCRIPTION OF THE DRAWINGS

The above-mentioned and other objects, features, advantages, technical and industrial significance of this invention will be better understood by reading the following detailed description of preferred embodiments of the invention, when considered in connection with the accompanying drawings, in which:

FIG. 1 is a cross sectional view showing part of an automatic transmission including a first planetary gear set and a second planetary gear set to which the invention is applied;

FIG. 2 is a view showing a flow of lubricating oil in the first planetary gear set in FIG. 1;

FIG. 3 is a view showing a first modified example in which a groove is formed at a position different from that in FIG. 1; and

FIG. 4 is a view showing a second modified example in which a groove is formed at a position different from that in each of FIG. 1 and FIG. 3.

### DETAILED DESCRIPTION OF THE PREFERRED EMBODIMENTS

In the following description and the accompanying drawings, the present invention will be described in more detail with reference to exemplary embodiments.

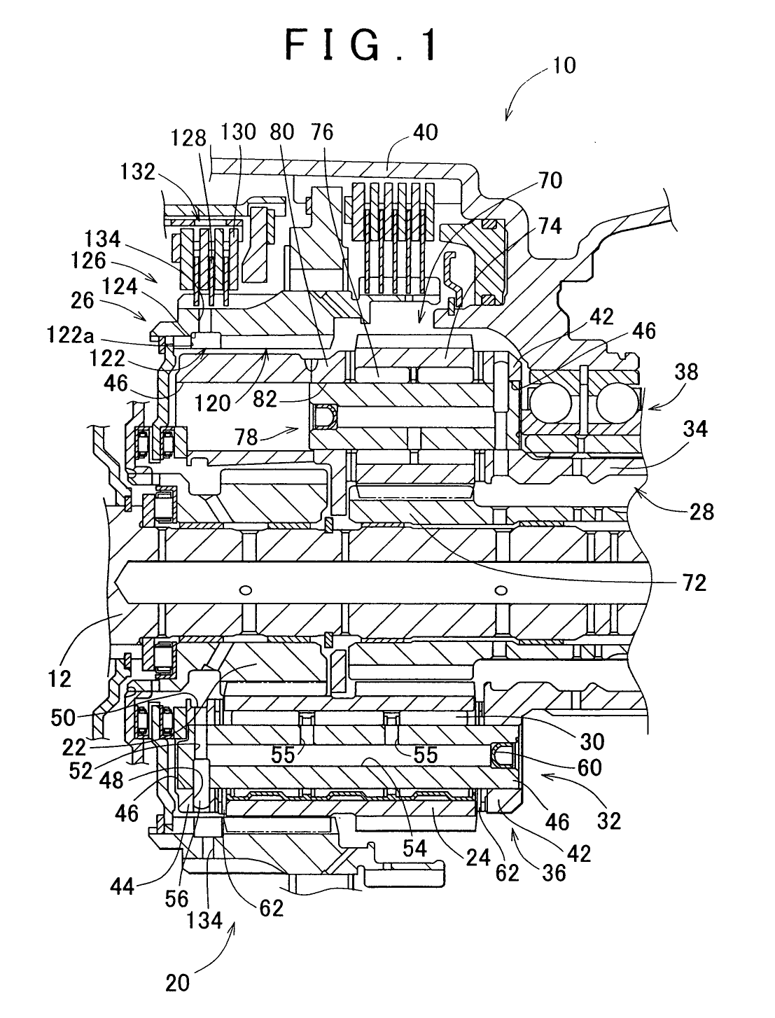

FIG. 1 is a cross sectional view showing part of an automatic transmission 10 including a first planetary gear set 20 and a second planetary gear set 70 to which the invention is applied.

The first planetary gear set 20 and the second planetary gear set 70 are so-called Ravigneaux type planetary gear sets. The first planetary gear set 20 and the second planetary gear set 70 are provided so as to be adjacent to each other, a carrier of the first planetary gear set 20 is coupled to a carrier of the second planetary gear set 70, a ring gear of the first planetary gear set 20 is coupled to a ring gear of the second planetary gear set 70, and the thus formed arrier and ring gear are shared by the first planetary gear set 20 and the second planetary gear set 70. The first planetary gear set 20 is a planetary gear set of a single pinion type. The first planetary gear set 20 includes a first sun gear 22; multiple long pinions 24; a ring gear 26 and a carrier 28 around an input shaft 12 serving as a turbine shaft of a torque converter that is driven by a running drive source such as an engine such that the first sun gear 22, the multiple long pinions 24, the ring gear 26 and the carrier 28 are rotatable with respect to each other. The first sun gear 22 is engaged with the input shaft 12 on an outer peripheral side of the input shaft 12. The multiple long pinions 24 are meshed with the first sun gear 22. The ring gear 26 is meshed with the long pinions 24. The carrier 28 supports the long pinions 24 such that each of the long pinions 24 can rotate on its axis and can revolve around first sun gear 22. Also, a long pinion shaft 32 is provided so as to penetrate each of the long pinions 24 along its axis in order to attach the long pinion 24 to the carrier 28 via a needle bearing 30.

The carrier 28 includes a shaft portion 34, and a support portion 36 which is coupled with one end of the shaft portion 34. When the shaft portion 34 is supported by a case 40 of the automatic transmission 10 via a bearing 38, the carrier 28 is attached to the case 40 such that the carrier 28 and the case 40 are rotatable with respect to each other. A disc-like first support wall 42 and a disc-like second support wall 44, which are perpendicular to the shaft portion 34, are formed at ends of the support portion 36 of the carrier 28 in the axial direction of the support portion 36.

In each of the first support wall 42 and the second support wall 44, through holes 46 are formed. The number of the through holes 46 formed in the first support wall 42 corresponds to the number of the long pinions 24 and after-mentioned short pinions 74. The number of the through holes 46 formed in the second support wall 44 corresponds to the number of the long pinions 24. Each of the long pinion shaft 32 is provided so as to penetrate the corresponding through hole 46 which is formed in each of the first support wall 42 and the second support wall 44, and the ends of the long pinion shaft 32 are supported by the support walls 42 and 44.

In the second support wall 44, there are formed an outer side radial direction hole 48, which is formed from the outer peripheral surface toward the inner side in the radial direction and which is communicated with the through hole 46; and an inner side radial direction hole 50, which is formed coaxially with the outer side radial direction hole 48, which is formed from the inner peripheral surface toward the outer side in the radial direction, and which is communicated with the through hole 46.

In the long pinion shaft 32, a first radial direction hole 52, which is communicated with the outer side radial direction hole 48 and the inner side radial direction hole 50 formed in the second support wall 44, is formed at one end portion of the long pinion shaft 32, the end portion being positioned at the end of the long pinion shaft 32 in the axial direction. Also, in the axis of the long pinion shaft 32, there is formed an axial direction hole 54, which extends parallel to the axial direction of the long pinion shaft 32, one end of which is communicated with the first radial direction hole 52, and the other end of which opens at a side surface of the long pinion shaft 32 at the other end portion. Two second radial direction holes 55 are formed at two positions so as to substantially trisect the axial direction hole 54 in the axial direction. One end of each the second radial direction holes 55 opens into the axial direction hole 54, and the other end opens at the outer peripheral surface of the long pinion shaft 32.

A pin 56 penetrates the outer side radial direction hole 48 of the second support wall 44 and is inserted in the first radial direction hole 52 of the long pinion shaft 32 up to a position close to the middle of the first radial direction hole 52, whereby the long pinion shaft 32 is fixed to the carrier 28. Also, a lid 60 for preventing an outflow of the lubricating oil is fitted in the axial direction hole 54 formed in the long pinion shaft 32 at the end portion on the side opposite to the first radial direction hole 52.

Also, washers 62 are provided such that one washer 62 is positioned between side surface of the first support wall 42 and one side surface of the long pinion 24 and the other washer 62 is positioned between the second support wall 44 and the other side surface of the long pinion 24.

The second planetary gear set 70 is a planetary gear set of a double pinion type. The second planetary gear set 70 includes a second sun gear 72 which is provided at a position adjacent to the first sun gear 22 and which is engaged with the input shaft 12 on the outer peripheral side of the input shaft 12 such that the input shaft 12 and the second sun gear 72 are rotatable with respect to each other; and multiple short pinions 74 which are meshed with the second sun gear 72 and which are also meshed with the long pinions 24. The second planetary gear set 70 is provided with the second sun gear 72; the short pinions 74; the long pinions 24; the carrier 28, the ring gear 26; and the like. Also, a short pinion shaft 78 is provided so as to penetrate each of the short pinions 74 along its axis in order to attach the short pinion 74 to the carrier 28 via a needle bearing 76.

A third support wall 80, which is in parallel with the first support wall 42 and the second support wall 44, is formed in the support portion 36 of the carrier 28 at a position close to the center of the support portion 36 in the axial direction. Through holes 82, in each of which one end of the short pinion shaft 78 is inserted, are formed in the third support wall 80. When the one end of the short pinion shaft 78 is inserted in the through hole 82 and the other end is inserted in the through hole 46 of the first support wall 42, the both ends of the short pinion shaft 78 are supported by the first support wall 42 and the third support 80.

A notch 122 is formed in each of the internal teeth 120 formed on the inner peripheral surface of the ring gear 26, the notch 122 being formed at a portion at which the internal teeth 120 are not meshed with the long pinions 24 at a position adjacent to the portion at which the internal teeth 120 are meshed with the long pinions 24. The notch 122 is formed by entirely cutting off the portion of each of the internal teeth 120, the portion being at the area in which the internal teeth 120 are not meshed with the long pinions 24 at the position adjacent to the portion at which the internal teeth 120 are meshed with the long pinions 24. In addition, a groove 124, which is slightly concave with respect to a bottom surface (root) of the internal teeth 120, is formed along the entire circumference of the inner peripheral surface of the ring gear 26 such that the groove 124 is formed so as to be contiguous to a side surface 122a of each notch 122.

The ring gear 26 also serves as a clutch hub. Spline grooves 126 are formed in the outer peripheral surface of the ring gear 26. Multiple outward friction plates 128 are engaged with the spline grooves 126. A clutch 132 is formed of the multiple outward friction plates 128 and multiple inward friction plates 130, the outward friction plates 128 and the inward friction plates 130 being laminated alternatively.

In the ring gear 26, there are formed multiple oil holes 134 at intervals in the circumferential direction. Each of the oil holes 134 penetrates the ring gear 26 in the radial direction of the ring gear 26. One end of the oil hole 134 opens at the bottom surface of the groove 124 and the other end opens at the bottom surface of the spline groove 126.

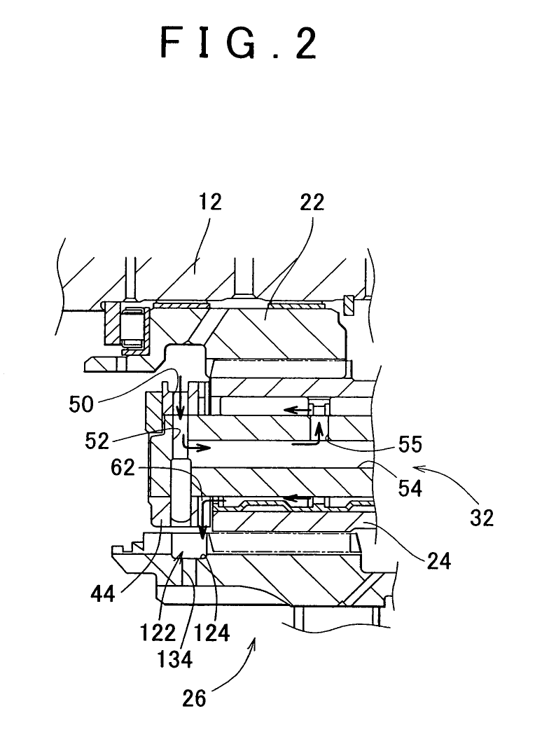

In the thus configured first planetary gear set 20, as shown by an arrow in FIG. 2, part of the lubricating oil discharged from the input shaft 12 in the radial direction of the input shaft 12 is supplied to the inner side radial direction hole 50 formed in the second support wall 44 of the carrier 28, and flows from the inner side radial direction hole 50 to the axial direction hole 54 through the first radial direction hole 52 formed in the long pinion shaft 32. Then, the lubricating oil is supplied from the axial direction hole 54 to the outer peripheral surface of the long pinion shaft 32 through the second radial direction holes 55, thereby lubricating the needle bearing 30. Further, the lubricating oil, which is supplied to the outer peripheral surface of the long pinion shaft 32 through the second radial direction holes 55, flows to the side surface of the long pinion 24 while spreading in the circumferential direction of the long pinion shaft 32 due rotation of the long pinion 24. Then, the lubricating oil supplied to the side surface of the long pinion 24 flows between the side surface of the long pinion 24 and the side surface of the washer 62, and is discharged to the outside of the long pinion 24 in the radial direction. Then, the lubricating oil, which is discharged from the side surface of the long pinion 24 to the outside of the long pinion 24 in the radial direction, flows through the notch 122, and flows into the groove 124 whose position in the axial direction of the long pinion 24 is the position adjacent to the side surface of the long pinion 24. Further, the lubricating oil, which is accumulated in the groove 124, is introduced to the outer peripheral surface of the ring gear 26 through the oil holes 134.

As described so far, according to the embodiment, the groove 124 is formed along the entire circumference of part of the inner peripheral surface of the ring gear 26. Therefore, the lubricating oil is easily accumulated in the groove 124. Also, the oil holes 134 open at the bottom of the groove 124. Accordingly, lubricity for the clutch 132 provided on the outer peripheral surface of the ring gear 26 is increased. Also, when the oil hole 134 is formed in the portion at which the internal teeth 120 are formed, it is not necessary to take the phase relationship between the spline grooves 126 and the internal teeth 120 of the ring gear 26 into consideration.

Also, according to the embodiment, the groove 124 is formed at the portion where the internal teeth 120 of the ring gear 26 are not meshed with the long pinions 24. Therefore, reduction of the strength of the internal teeth 120 of the ring gear 26 due to the groove 124 is prevented. Also, the groove 124 is formed at the position adjacent to the side surfaces of the long pinions 24 in the range where the internal teeth 120 of the ring gear 26 are not meshed with the long pinions 24. Therefore, the lubricating oil discharged outward in the radial direction on the side surface of the long pinion 24 is easily introduced into the groove 124. Accordingly, the lubricating oil is accumulated in the groove 124 considerably easily. As a result, lubricity for the clutch 132 is further increased.

The embodiment of the invention has been described in detail with reference to accompanying drawings. However, the invention can be realized in the other embodiments.

For example, in the above-mentioned embodiment, the planetary gear sets 20 and 70 are so-called Ravigneaux type planetary gear sets. However, the invention can be applied to planetary gear sets other than a Ravigneaux type planetary gear set.

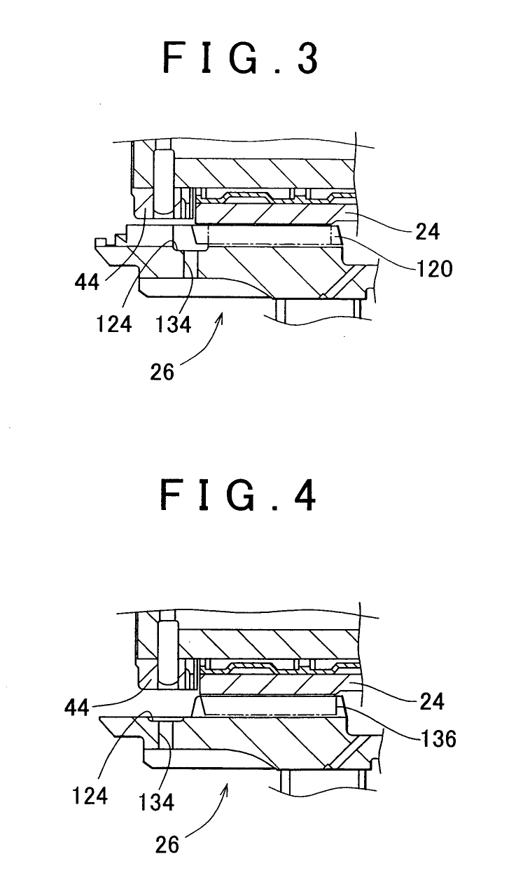

Also, in the above-mentioned embodiment, the groove 124 is formed at the position adjacent to the side surfaces of the long pinions 24 in the range where the internal teeth 120 of the ring gear 26 are not meshed with the long pinions 24. However, as shown in a first modified example in FIG. 3, the groove 124 may be formed such that part of the groove 124 is at a position on the side, on which the internal teeth 120 of the ring gear 120 are meshed with the long pinions 24, with respect to the side surfaces of the long pinions 24, and the other portion of the groove 124 is at a position at which the internal teeth 120 of the ring gear 26 are not meshed with the long pinions 24. Even when the groove 124 is formed in this manner, the lubricating oil discharged outward in the radial direction on the side surface of the long pinion 24 is easily introduced into the groove 124.

Also, as in shown in a second modified example in FIG. 4, when internal teeth 136 of the ring gear 26 are formed only up to the position near the side surfaces of the long pinions 24, and there is a portion, at which the internal teeth 136 are not formed, in the inner peripheral surface of the ring gear 26, the groove 124 may formed in the inner surface of the ring gear 26 at a portion which is on the outside with respect to the internal teeth 136 in the axial direction of the ring gear 26.

While the invention has been described with reference to exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A planetary gear set, comprising
a sun gear;
a carrier which rotatably supports multiple pinions meshed with the sun gear; and
a ring gear in which internal teeth meshed with the pinions are formed in an inner peripheral surface and in which spline grooves are formed on an outer peripheral surface such that the ring gear serves as a hub of friction plates, wherein
a groove is formed along an entire circumference of part of the inner peripheral surface of the ring gear, and oil holes for introducing lubricating oil from an inner peripheral side to an outer peripheral side of the ring gear are formed such that one end of each of the oil holes opens at a bottom of the groove.

2. The planetary gear set according to claim 1, wherein
the groove is formed in the inner peripheral surface of the ring gear at a portion at which the internal teeth are not meshed with the pinions.

3. The planetary gear set according to claim 2, wherein
the groove is formed in the inner peripheral surface of the ring gear at the portion at which the internal teeth are not meshed with the pinions at a position adjacent to side surfaces of the pinions.

4. The planetary gear set according to claim 1, wherein
part of the groove is formed in the inner peripheral surface of the ring gear at a portion at which the internal teeth of the ring gear are meshed with the pinions.
